(19) United States
(12) Patent Application Publication
(10) Pub. No.: US 2016/0047939 A1
(43) Pub. Date: Feb. 18, 2016

(54) A METHOD AND APPARATUS FOR DETECTION OF NATURAL RESOURCES

(71) Applicant: Michael Mumelter, St. Andrae (AT)

(72) Inventor: Michael Mumelter, St. Andrae (AT)

(21) Appl. No.: 14/235,827

(22) PCT Filed: Apr. 29, 2013
(86) PCT No.: PCT/EP2013/058929

§ 371 Date: Jan. 29, 2014

(51) Int. Cl. G01V 8/02; G01V 99/00

(52) U.S. Cl. CPC G01V 8/02; G01V 99/00

(57) ABSTRACT

A detection system for detection of natural resources beneath a target surface of an area under investigation comprising a calculation unit adapted to calculate an exploration map of likely locations of natural resources beneath the target surface of the investigated area by superimposing independent analytical maps of the investigated area generated by processing satellite images of the investigated area provided by satellites.

The invention relates to a method and apparatus for detection of natural resources beneath a target surface of an area under investigation, in particular a method and apparatus for detection of hydrocarbons.

With the increasing demand for natural resources the exploration of natural resources becomes more important. Natural resources which can be found under the earth's surface can comprise gas, fluids, in particular water or hydrocarbons, mineral resources, metals, for instance gold or silver or uranium, lithium and diamonds. Especially, the exploration of hydrocarbons including oil and gas beneath the earth surface is of the utmost importance. Surface features such as oil seeps, natural gas seeps, can provide basic evidence of hydrocarbon deposits.

Conventional exploration methods are provided to detect and determine an extent of deposits using for instance exploration geophysics. Areas that may contain deposits are subjected for example to a gravity survey, magnetic survey, or seismic reflection surveys to detect features of the subsurface geology beneath the target surface of the investigated area. The area of interest can then be subjected to more detailed seismic surveys which work on the principle of the time it takes for reflected sound waves to travel through matter of varying densities and using the process of depth conversion to create a profile of the layers beneath the target surface. Finally, when a prospect has been identified an exploration well can be drilled in an attempt to conclusively determine whether a natural resource is present or not. As a common assessment method a seismic method is used for identifying geological structures. This method relies on the differing reflective properties of sound waves travelling through various layers beneath terrestrial or oceanic surfaces. An energy source can transmit a pulse of acoustic energy into the ground which travels as a wave into the earth. At each point where a different geological strata exists a part of the energy is transmitted down to deeper layers within the earth while the remainder is reflected back to the surface. At the surface, the reflected signals are picked up by a series of sensitive receivers comprising geophones or seismometers on land or hydrophones submerged in water. In the seismic method an energy source transmits a pulse of acoustic energy into the ground. Previously dynamite was used as the energy source, however, because of environmental considerations other energy sources, for instance generators which hydraulically transmit vibrations into the ground, are commonly used.

To support the exploration, satellites can be used providing images of the investigated area. By remote sensing, the satellites acquire information about the investigated area without making any physical contact. In conventional systems the provided satellite images are used as auxiliary information to the other assessment methods such as seismic investigations.

The conventional exploration methods are not satisfactory because the probability of finding natural resources on the basis of the results as provided by the common assessment methods is relatively low. Accordingly, exploration still forms an expensive high-risk operation.

Consequently, there is a need to provide a method and apparatus for detection of natural resources beneath a target surface of an area under investigation which significantly increases the probability of finding natural resources.

This object is achieved by a method comprising the features of claim 1.

According to a first aspect of the present invention, a method for detection of natural resources beneath a target surface of an area under investigation is provided.

In a possible embodiment of the method for detection of natural resources beneath a target surface of an area under investigation according to the first aspect of the present invention, the method comprises the steps of:

remote sensing of electromagnetic radiation received from said target surface to provide satellite images of the investigated area,
processing the satellite images of the investigated area to generate analytical maps of the investigated area, and
calculating an exploration map of likely locations of natural resources beneath the target surface of said investigated area by superimposing generated analytical maps.

With the method according to the present invention, the success rate for detection of natural resources is increased.

A further advantage of the method according to the present invention is that the exploration time for finding deposits of a natural resource beneath a surface is diminished significantly.

A further advantage of the method according to the present invention is that the ecological impact on the environment during the exploration process is minimized.

In a possible embodiment of the method according to the first aspect of the present invention, the exploration map of likely locations of natural resources beneath the target surface of the investigated area is calculated by superimposing at least two independently generated analytical maps.

In a further possible embodiment of the method according to the present invention, satellite images of the investigated area are processed to generate an analytical structural trapping map of the investigated area indicating geological arc and/or ring structures beneath the target surface of the investigated area which indicate potential trapping mechanisms for trapping natural resources.

In a further possible embodiment of the method according to the present invention, infrared satellite images of the investigated area are processed to generate an analytical thermal anomalies map of the investigated area indicating anomalies caused by natural resources beneath the target surface of the investigated area.

In a further possible embodiment of the method according to the first aspect of the present invention, satellite images of the investigated area are processed to generate at least one analytical spectral brightness anomalies map of the investigated area indicating anomalies caused by natural resources beneath the target surface of the investigated area.

In a still further possible embodiment of the method according to the first aspect of the present invention, the analytical thermal anomalies map and the at least one analytical spectral brightness anomalies map are superimposed to generate an analytical seepage map of the investigated area.

In a still further possible embodiment of the method according to the present invention, the generated analytical seepage map and the generated analytical structural trapping map are superimposed to calculate the exploration map of the investigated area.

In a further possible embodiment of the method according to the present invention, geological data, lithological data and geophysical data of the investigated area are superimposed to the exploration map comprising coordinates of likely locations of natural resources beneath the target surface of the investigated area.

In a further possible embodiment of the method according to the first aspect of the present invention, the satellite images are provided by different satellites and transmitted to a base station connected to at least one calculation unit adapted to process the received satellite images to generate the independent analytical maps of the investigated area.

In a further possible embodiment of the method according to the first aspect of the present invention, the received satellite images are selected and processed by the calculation unit depending on an exploration task indicating a type of the searched natural resources to be explored in the investigated area to generate independent analytical maps suited for the respective natural resource.

In a still further possible embodiment of the method according to the first aspect of the present invention, the geological, lithological, and geophysical data superimposed to the exploration map of the investigated area are selected and processed depending on the exploration task indicating the type of the searched natural resource to be explored in the investigated area.

In a still further possible embodiment of the method according to the first aspect of the present invention, the remote sensing of the electromagnetic radiation is performed by satellites which measure an electromagnetic radiation emitted by the target surface or reflected by the target surface to provide satellite images of the investigated area.

In a still further possible embodiment of the method according to the first aspect of the present invention, the remote sensing of electromagnetic radiation is performed by satellites which transmit electromagnetic signals to the target surface and measure an electromagnetic radiation reflected by the target surface in response to said electromagnetic signals to generate satellite images of the investigated area.

In a still further possible embodiment of the method according to the first aspect of the present invention, the satellite images are provided for electromagnetic radiation emitted or reflected by the target surface in different spectral ranges.

In a still further possible embodiment of the method according to the first aspect of the present invention, the spectral ranges of the satellite images are selected depending on the type of natural resources indicated in the exploration task input by a user.

In a further possible embodiment of the method according to the first aspect of the present invention, the investigated area comprises an on-shore area.

In a further possible embodiment of the method according to the first aspect of the present invention, the investigated area comprises an off-shore area under shallow water having a maximum depth of 200 meters.

In a still further possible embodiment of the method according to the first aspect of the present invention, the calculated exploration map comprises statistical data indicating probabilities of the availability and/or distribution and/or motion of a natural resource at geographical coordinates beneath the target surface within the investigated area.

In a still further possible embodiment of the method according to the first aspect of the present invention, control data adapted to control exploration machines and/or to control exploration sensors at the investigated area are derived from the calculated exploration map.

In a still further possible embodiment of the method according to the first aspect of the present invention, the type of natural resources indicated in the exploration task comprises gas, fluids, in particular water or oil, mineral resources, metals, in particular gold, uranium, lithium and/or diamonds.

The invention further provides according to a second aspect a detection system for detection of natural resources beneath a target surface of an area under investigation.

In a possible embodiment of the detection system according to the second aspect of the present invention, a calculation unit is provided being adapted to calculate an exploration map of likely locations of natural resources beneath the target surface of the investigated area by superimposing independent analytical maps of the investigated area generated by processing satellite images of the investigated area provided by satellites.

In a possible embodiment of the detection system according to the second aspect of the present invention, the calculation unit is adapted to calculate the exploration map of natural resources beneath the target surface of the investigated area by superimposing the independent analytical maps of the investigated area stored in a first database and geological data, lithological data and/or geophysical data of the investigated area stored in second databases connected to the calculation unit of the detection system via a data network.

In a further possible embodiment of the detection system according to the second aspect of the present invention, the satellite images received from the satellites are stored in an image data memory of the detection system and processed by the calculation unit of the detection system to generate the independent analytical maps of the investigated area stored in the first database of the detection system.

In a further possible embodiment of the detection system according to the second aspect of the present invention, the satellite images stored in the image data memory are selected and processed by the calculation unit of the detection system to generate the independent analytical maps depending on the exploration task indicating a type of the searched natural resource to be explored input by a user into a user interface of the detection system.

In a still further possible embodiment of the detection system according to the second aspect of the present invention, the superimposing of the generated analytical maps of the investigated area stored in the first database of the detection system and the geological data, lithological data and/or geophysical data of the investigated area stored in the second databases connected to the detection system is performed by the calculation unit depending on the exploration task input by the user into the user interface of the detection system.

In a still further possible embodiment of the detection system according to the second aspect of the present invention, the calculation unit is adapted to derive control data to control exploration machines and/or exploration sensors at the investigated area on the basis of the calculated exploration map.

In a still further possible embodiment of the detection system according to the second aspect of the present invention, the calculation unit is further adapted to output the exploration map to said user via a user interface.

In the following, possible embodiments of the method and apparatus according to different aspects of the present invention are described in more detail with reference to the enclosed figures.

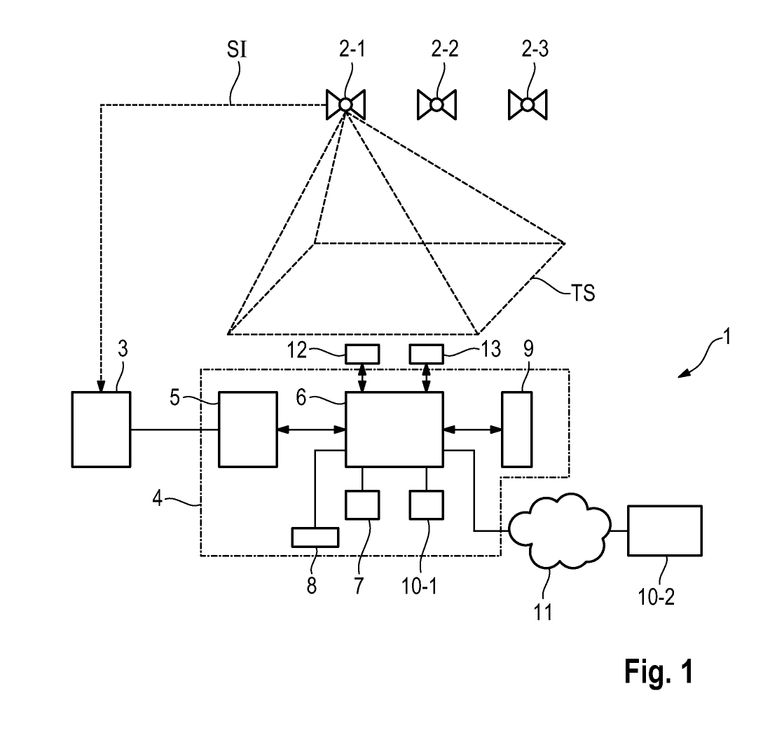

FIG. 1 shows a block diagram for illustrating a possible embodiment of a detection system according to an aspect of the present invention;

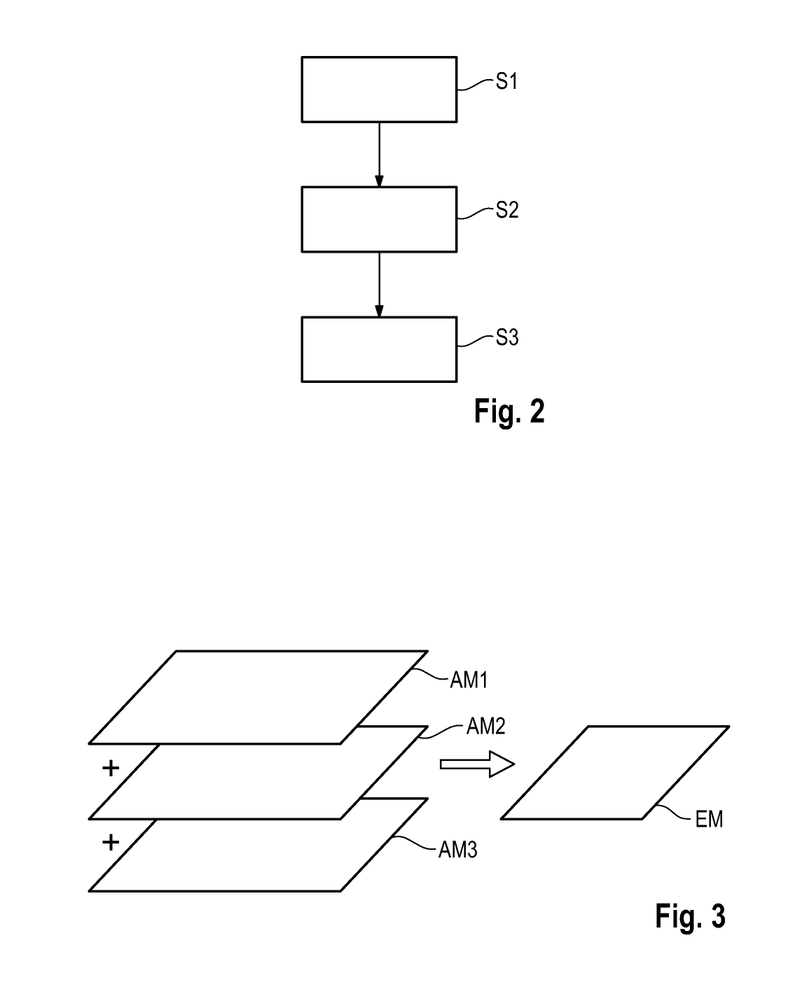

FIG. 2 shows a flow chart of a possible embodiment of a method for detection of natural resources according to an aspect of the present invention;

FIG. 3 shows a schematic diagram for illustrating the operation of a method and apparatus for detection of natural resources according to the present invention;

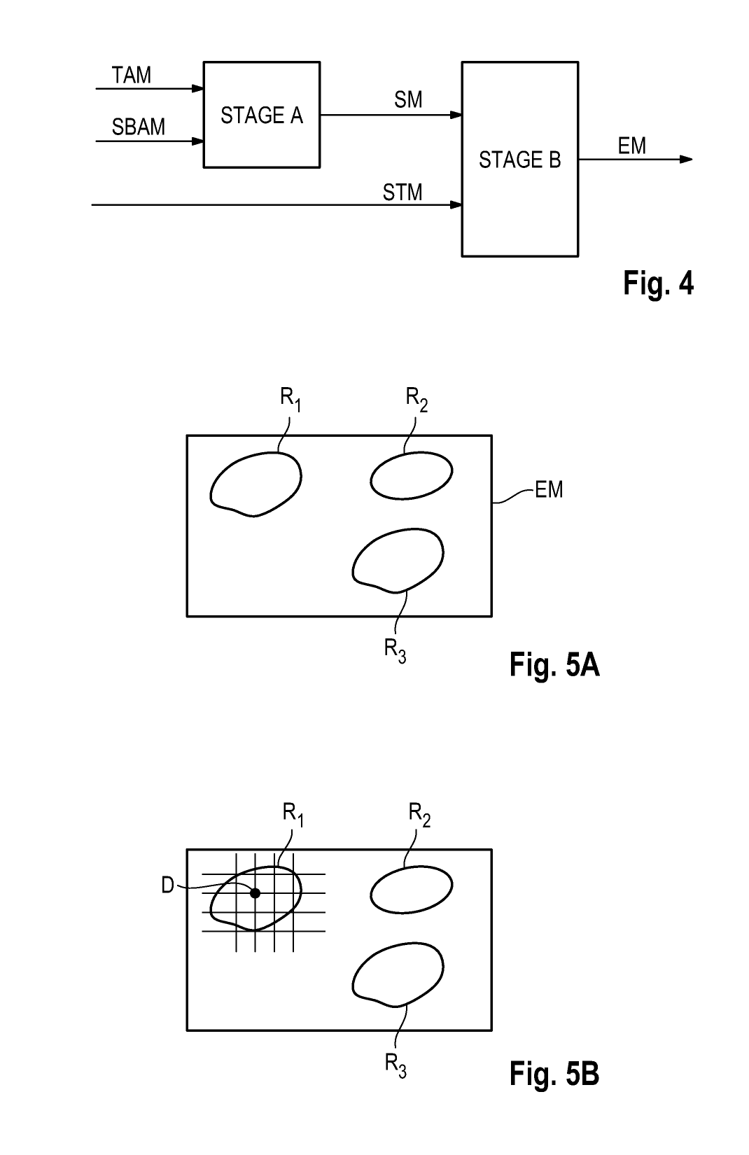

FIG. 4 shows a further diagram for illustrating a possible implementation of a method and apparatus for detection of natural resources according to the present invention;

FIGS. 5A, 5B show simplified exploration maps for illustrating the operation of a method and apparatus for detection of natural resources according to the present invention.

As can be seen in FIG. 1, the detection system 1 for detection of natural resources according to the first aspect of the present invention is provided for detection of natural resources such as gas and/or oil beneath a target surface of the area under investigation. In FIG. 1, a target surface TS of an investigated area is illustrated. The investigated area can comprise an on-shore area on land. It is further possible that the investigated area comprises an off-shore area under shallow water having a predetermined maximum depth of e.g. 200 meters. In the shown embodiment of FIG. 1, there are different satellites 2-1, 2-2, 2-3 which provide satellite images of the target surface TS. The satellite images SI provided by the different satellites 2-i are transmitted to a base station 3 as shown in FIG. 1. The base station 3 can be connected to an evaluation center 4 of the detection system 1. The evaluation center 4 can comprise an image data memory 5 adapted to store satellite images SI. The selected satellite images SI transmitted by the satellites 2-i to the base station 3 are relayed by the base station 3 to the image data memory 5 of the evaluation center 4 as shown in FIG. 1. The image data memory 5 is connected to a calculation unit 6 which is adapted to process the received satellite images SI to generate the independent analytical maps AM of the investigated area. The calculation unit 6 can comprise one or several processors or microprocessors. The calculation unit 6 of the detection system 1 is adapted to calculate an exploration map EM of likely locations of natural resources beneath the target surface TS of the investigated area by superimposing independent analytical maps AM of the investigated area generated by processing satellite images SI of the investigated area provided by the satellites 2-i. In the embodiment shown in FIG. 1, the satellite images SI received from the satellites 2-i are stored in the image data memory 5 of the detection system 1 and processed by the calculation unit 6 of the detection system 1 to generate independent analytical maps AM of the investigated area which can be stored in a first database 7 of the detection system 1 as shown in FIG. 1. In a possible embodiment, the satellite images SI stored in the image data memory 5 can be selected and processed by the calculation unit 6 of the detection system 1 to generate the independent analytical maps AM to be stored in the first database 7 depending on an exploration task ET. This exploration task ET can indicate a type of the searched natural resource to be explored. The exploration task ET can in a possible embodiment indicate the type of the searched natural resource including the type of a gas or fluid, in particular hydrocarbons, oil or water. Further, the exploration task ET can indicate mineral resources to be searched, for instance metals, in particular gold or silver or uranium, lithium or diamonds. In a possible embodiment of the detection system 1 according to the first aspect of the present invention, the exploration task ET can be input by a user, such as an engineer, into a user interface 8 of the evaluation center 4 as illustrated in FIG. 1. The superimposing of the generated analytical maps AM of the investigated area stored in the first database 7 of the evaluation center 4 is performed by the calculation unit 6 depending on the input exploration task ET to generate an exploration map EM. The exploration map EM can in a possible embodiment be output by the calculation unit 6 via a further interface 9 to the user. In a still further possible embodiment, the calculation unit 6 can superimpose to the generated analytical maps AM additional data stored in a further database 10. This additional data can comprise geological data, lithological data and geophysical data of the investigated area. This data can be stored in second databases 10-1 connected to the calculation unit 6. In a further possible embodiment, the superimposing of the analytical maps and of the additional data is performed by the calculation unit 6 also depending on the input exploration task ET. The second databases can be provided at the evaluation center 4 or connected via a data network 11 such as the internet to the calculation unit 6. In the shown embodiment of FIG. 1, the local second database 10-1 is provided and a remote second database 10-2 is connected to the evaluation center 4 via a data network 11.

In a possible embodiment, the calculation unit 6 is further adapted to derive control data to control exploration machines 12 or exploration sensors 13 at the investigated area on the basis of the calculated exploration map EM. In the detection system 1 according to the present invention as illustrated in FIG. 1, the exploration map EM is automatically calculated and generated by superimposing several independent analytical maps AM and possibly additional data such as geological, lithological and geophysical data. With the detection system 1 according to the first aspect of the present invention, satellites 2-i perform a remote sensing of electromagnetic radiation received from the target surface TS to provide the satellite images SI of the investigated area. These satellite images SI are then transmitted to the base station 3 which relays the satellite images SI to the image data memory 5 of the evaluation center 4. The satellite images SI stored in the image data memory 5 are processed by the calculation unit 6 to generate analytical maps AM of the investigated area.

In a possible embodiment, the satellite images SI of the investigated area are processed to generate an analytical structural trapping map STM of the investigated area. This structural trapping map STM indicates geological arc and/or ring structures beneath the target surface TS of the investigated area. Further, infrared satellite images SI of the investigated area can be processed by the calculation unit 6 to generate an analytical thermal anomalies map TAM of the investigated area. This analytical thermal anomalies map TAM of the investigated area indicates anomalies caused by natural resources beneath the target surface TS of the investigated area. Further, satellite images SI of the investigated area can be processed by the calculation unit 6 to generate at least one analytical spectral brightness anomalies map SBAM of the investigated area. This spectral brightness anomalies map SBAM can indicate anomalies caused by natural resources beneath the target surface TS of the investigated area. In a possible embodiment of the detection system 1 as illustrated in FIG. 1, the analytical thermal anomalies map TAM and at least one analytical spectral brightness anomalies map SBAM as well as the analytical structural trapping map STM can be stored in the local database 7 of the evaluation center 4. In a further possible step, the calculation unit 6 of the detection system 1 does superimpose automatically the analytical thermal anomalies map TAM and the at least one analytical spectral brightness anomalies map SBAM to generate an analytical seepage map of the investigated area. This generated analytical seepage map SM can also be stored in the local database 7 of the evaluation center 4. After having generated the analytical seepage map SM of the investigated area, the analytical seepage map SM can be read from the database 7 and be superimposed to the generated analytical structural trapping map STM to calculate the exploration map EM of the investigated area. Accordingly, in this embodiment, the superimposing of analytical maps AM is performed in two stages as also illustrated in FIG. 4. In the first stage A, the analytical thermal anomalies map TAM and at least one analytical spectral brightness anomalies map SBAM are superimposed automatically by the calculation unit 6 executing a superimposing process to generate the analytical seepage map SM. In a further stage B, the generated analytical seepage map SM is then superimposed automatically by the calculation unit 6 with the analytical structural trapping map STM to calculate the exploration map EM of the investigated area which can then be output by a graphical user interface 9 to the user. The generated exploration map EM can also be printed by a peripheral printing device. In a possible embodiment, the generated exploration map EM can undergo a further superimposing process by superimposing additional data comprising geological data, lithological data and/or geophysical data, for instance read from the databases 10-1, 10-2 as shown in FIG. 1.

In the detection system 1 as shown in the embodiment of FIG. 1, a remote sensing of the electromagnetic radiation is performed by the satellites 2-i. The satellites measure an electromagnetic radiation emitted by the target surface TS or reflected by the target surface TS to provide the satellite images SI of the investigated area. The remote sensing of the electromagnetic radiation can be performed by satellites 2-i which transmit electromagnetic signals to the target surface TS which measure an electromagnetic radiation reflected by the target surface TS in response to the electromagnetic signals to generate the satellite images SI of the investigated area. These satellite images SI are then transmitted by the satellites 2-i to the base station 3. The satellite images SI can be provided for electromagnetic radiation emitted or reflected by the target surface TS in different spectral ranges. In a possible embodiment, the spectral ranges of the satellite images SI are automatically or normally selected depending on the type of the natural resource indicated in the exploration task ET input by the user, for instance via the user interface 8.

In a possible embodiment, the calculated exploration map EM does also comprise statistical data indicating probabilities of the availability of the respective natural resource. The statistical data can also indicate a distribution or even a motion vector of a motion of a natural resource at specific geographical coordinates beneath the target surface TS within the investigated area. Moreover, the calculated exploration map EM can also comprise itself control data or can form the data basis for deriving such control data. These control data can comprise control data to control exploration machines 12 and/or exploration sensors 13 at the investigated area.

FIG. 2 shows a flow chart of a possible embodiment of the method for detection of natural resources beneath the target surface TS of the area under investigation. In a first step S1, a remote sensing of electromagnetic radiation received from the target surface TS is performed to provide satellite images SI of the investigated area. In a second step S2, the received satellite images SI of the investigated area are processed to generate analytical maps AM of the investigated area. These analytical maps AM can comprise for instance an analytical thermal anomalies map TAM, an analytical structural trapping map STM and one or several analytical spectral brightness anomalies maps SBAM. In a third step S3, an exploration map EM of likely locations of the searched natural resources beneath the target surface TS of said investigated area is calculated by superimposing the analytical maps AM generated in step S2.

The exploration map EM provides a structured image of the studied area. The consistency of the image with real facts determines the quality and reliability of the prognosis. The utilization of remote sensing data facilitates the reading of a set of structural features of the objects of a geological survey, i.e. linear features, folding list locations, ring, arc and block features. The interpretation of structural features can be restricted by climate, exposure of geological features and their relief manifestations. Remote sensing data does enable to elicit information which is otherwise unobtainable and can only be provided with much labour and efforts. Rectilinear and slightly curved features (lineament) respond to high-angle folds and fractures. Arc, oval and ring features are known under the general name of ring structures. These ring structures do vary in genesis, age, shape, structural complexity, size, structural and material relations, depth strike and manifestation in the relief. The majority of these features is oval in shape, next order of decreasing frequency come approximately round features and then features with regular round outline. Both external margins and internal parts of ring structures cannot always be closed, but they are more often represented by fragments of occasionally cuspate contours which integrally form the feature to some extent close in structure to a ring feature. Regarding the substance that makes up ring structures it can be pointed out as a general rule that the lesser the size the more homogeneous the composition will be. Major ring structures enclose complex formations of diverse genesis, composition and age, including transitional relatively to the proper features depending on the ratio of them. Ring structures are of major significance, in particular for oil and gas prospectivity forecast since two thirds of hydrocarbon fields worldwide are found in anticline- or cupola-type of traps. Ring structures can match cupolas, brachsynclines and their fragments along with local heights. Accordingly, an analytical structural trapping map STM of the investigated area indicates geological arc and/or ring structures beneath the target surface TS which indicate potential trapping locations of natural resources, in particular hydrocarbons.

A further analytical map AM which can be generated by processing the satellite images SI is an analytical thermal anomalies map TAM. The thermal anomalies map TAM indicates anomalies caused by natural resources beneath the target surface TS of the investigated area.

In a possible implementation, an earth surface temperature data set is provided by a satellite image SI of the temperatures in the investigated area. A data set can for instance consist of a NOAA-AVHRR satellite image. An advantage of using this satellite image consists in the feasibility of thermal infrared band images during the night in the absence of direct solar impact on the earth's surface temperature. The available information on temperature anomalies over oil and gas fields demonstrates that positive (exothermic reaction dominating) or negative (endothermic reaction dominating) temperature anomalies build up over natural resources, in particular over oil and gas fields depending on physical and/or chemical processes in the deposit, in particular in a hydrocarbon reservoir and its surroundings. For instance, positive temperature anomalies are characteristic for fields with methane oils (relative light as a rule) while those with negative temperature anomalies are associated with fields with heavier oils, gas and gas condensate fields.

Further, the satellite images SI of the investigated areas can be processed to generate at least one analytical spectral brightness anomalies map SBAM of the investigated area which indicate anomalies caused by natural resources beneath the target surface TS of the investigated area. In a possible implementation, earth's surface areas are identified where spectral properties registered in several channels differ on specific relations that are characteristic of benchmark features and not inherent in the surrounding area. Such properties are specific anomalies of spectral brightness. For instance, multi-spectral space image for hydrocarbon deposits prospecting stems from the fact that specific anomalies of spectral brightness in images are established on the daytime surface over numerous deposits. This can be caused by thermals or plutonic waters and gases occurring over these deposits and affecting the temperature field of the earth surface. The specific spectral brightness anomalies are stipulated by the differences in temperatures of the daytime surface, geochemical anomalies of macro- and microelements and peculiarities of soils and vegetation derived from it. These specific anomalies of spectral brightness can be discovered according to subtle differences in features registered in different channels of multi-spectral space images. In a possible implementation, an interchannel transformation method ITM is applied for the identification of spectral brightness anomalies. In a possible embodiment, different spectral brightness anomalies maps SBAM are generated for different natural resources, for instance a spectral brightness anomalies map for oil and a spectral brightness anomalies map for gas. In a possible embodiment, the spectral brightness anomalies maps and the thermal anomalies map TAM are superimposed to calculate a seepage map SM. In a possible implementation, further available data comprising geological, lithological and geophysical data can be integrated. By a holistic approach a maximum amount of relevant properties and information is generated and integrated in the exploration map EM. The exploration map EM comprises recommended prospective areas for the searched natural resource. The analysis of the multi-spectral space images for the survey of deposits are connected with the determination of specific anomalies of spectral brightness. Further, specific anomalies are caused by upstreaming fluxes of water and/or gases that can affect the temperature of the surface in the investigated area.

In a possible embodiment, the remote sensing data can be exported and stored together with cartographic data as layers of spatially distributed geo-referenced databases. With the structural lineament analysis, a systematic search for linear objects through an automated process (SLARD) can be performed. Linear objects can comprise faults, deep breaks and linear deformation structures including fissures. Linear elements in space images are comparable with faults and other structural zones. With the automated SLARD process it is possible to find such zones and through statistical-formal analysis to define such structures. The results of a lineament analysis are diagrams of abnormal lineament fields of some regions which allow for the forecasting of various geological structures including local carbon traps and the understanding of the conditions for the formation and distribution of underground water flows. A hydrogeological evaluation allows for the understanding of how underground water flow depending upon geomorphological structures, structural tectonic conditions, physical and geographical factors. Furthermore, it can provide information data on vectors, i.e. the subsoil water motion, spatial regions of the sources, flow, consumption and boundaries of sweet fresh water lenses (caverns). According to a possible embodiment, with the method and apparatus according to the present invention it is possible to find water deposits and even water flows beneath the surface. With the detection system 1 according to the present invention it is possible to detect and determine the character of subsoil water distribution and deposits. Further, it is possible to detect prospects and leads of oil and gas availability. Further, it is possible to detect and determine mineral resources comprising for instance uranium, lithium, gold and diamonds. The detection system 1 according to the first aspect of the present invention performs a systematic analysis of the earth's surface by using high-resolution satellite images SI and geo-information data.

FIG. 2 shows a flow chart of a possible embodiment of a method for detection of natural resources beneath a target surface TS of an area under investigation according to an aspect of the present invention. In a possible implementation, further steps can be performed to even increase the reliability of the prediction of natural resource deposits. In a possible embodiment, these further steps can include geochemical investigations including for instance microbiological oil survey techniques (MOST) and high-resolution geochemistry (HRGC). Further steps can include non-seismic geophysical processes including a high-resolution ground magnetic evaluation (HRGM) to test for distinctive magnetic signatures of deposits. Further investigations can be a high-resolution ground gravity evaluation (HRGG) and a magneto-telluric evaluation (MT) for measuring of low frequency currents in the earth's crust to determine a type of subsurface structure such as minerals, petroleum reservoirs, geothermal fields, ground water reservoirs. Further, possible non-seismic geophysical methods can comprise controlled source electromagnetic (CSEM) and/or passive seismic (PS) evaluations.

FIG. 3 illustrates a superimposing of generated analytical maps AM to calculate an exploration map EM. In a possible implementation, the superimposing of the analytical maps AM can be performed in one stage or in several stages as illustrated for instance in FIG. 4. In the simple example of FIG. 3, three analytical maps AM1, AM2, AM3 are superimposed to generate the exploration map EM. The analytical maps AM can comprise for instance an analytical structural trapping map STM, an analytical thermal anomalies map TAM as well as at least one analytical spectral brightness anomalies map SBAM. The calculation unit 6 of the detection system 1 calculates the exploration map EM by superimposing the analytical maps AM AM-i. The superimposing can be performed in a possible embodiment pixelwise wherein each pixel value of the exploration map EM is calculated according to a predetermined superimposing function SF depending on the pixel values of the corresponding pixels within the analytical maps AM AM1, AM2, AM3. For instance, the pixel value of a pixel within the exploration map EM can be calculated as follows:

P_{EM}=W1×P₁+W2×P₂+W3×P₃,

wherein Pᵢ are the pixel values of the analytical maps AM AM-i and Wᵢ are weighting factors. In a possible embodiment, the weighting values Wᵢ or factors are adjustable, for instance by a user via a user interface. The calculation of the pixel values of the exploration map EM can be performed also by other linear or nonlinear superimposing functions SF selectable by the user or selected automatically depending on the exploration task ET specified by the user.

FIG. 5A illustrates a simplified exploration map EM showing different regions Rᵢ within the investigated area where likely locations of natural resources beneath the target surface TS. In the simple exploration map EM of FIG. 5A there are three areas or regions R1, R2, R3. In a possible embodiment, the calculated exploration map EM can also comprise statistical data indicating probabilities of the availability of natural resources at geographical coordinates beneath the target surface TS within the investigated area. For instance, the probability of the availability of a specific natural resource in a region R1 can be higher than the probability of the availability of the same resource in the region R2. Accordingly, drilling can be performed first in the region R1 having the highest probability to find the respective natural resource beneath the surface. A drilling grid can be applied to the selected region as shown in FIG. 5B and the drilling can be performed at a specific location D within the region R1 as illustrated in FIG. 5B. Drilling is performed by a drilling rig which can be dismantled after drilling and initial testing and then moved to the next site. When the exploratory drilling is successful more holes can be drilled to determine the size and extent of the deposit.

With the method according to the present invention various independent analytical maps AM including structural lineament analysis, analysis of thermal infrared images and spectral analysis can be superimposed and additional data comprising geological and lithological data as well as geophysical data can be incorporated. The calculated exploration map EM comprises a high resolution as well as a detailed description of the geological structure as well as an exact location of potential deposits of the searched natural resource. With the method and system according to the present invention it is possible to detect natural resources including hydrocarbons, diamonds, gold, uranium, lithium and the very valuable resource water. The method can be applied for on-shore as well as for off-shore exploration of natural resources. With the method according to the present invention it is possible to calculate the location of natural resource deposits in an effective, quick and accurate manner. Further, the method is very friendly to the environment.

In a possible embodiment, the detection system 1 also generates control data to control the remote sensing of the satellites 2-i shown in FIG. 1. These control signals and control data can be provided to adapt a spectral range of the generated satellite images SI. By adjusting the frequency range of the satellite images SI it is possible to adapt the generated satellite images SI to the natural resource searched according to the exploration task ET. In a possible embodiment, the exploration task ET can comprise data indicating the searched natural resource and/or the relevant spectral ranges to be used by the satellites 2-i for generating the satellite images SI. Accordingly, it is an advantage of the method and detection system 1 according to the present invention that it can be easily adapted to search for different kinds of natural resources.

In a possible embodiment, the generated exploration map EM can also be stored in a database, for instance in the local database 7 of the evaluation center 4 shown in FIG. 1.

In a possible embodiment, the results provided by the drilling at a location indicated by the exploration map EM can be correlated to the exploration map data to optimize the superimposing functions SF used by the calculation unit 6 when superimposing the generated analytical maps AM. In a still further possible embodiment of the method and system according to the present invention, it is possible that the satellite images SI provided by the satellites 2-i are generated also in response to control data and/or environmental data. For instance, remote sensing of the target surface TS can be performed in different frequency ranges depending on the local time at the target surface TS, e.g. whether it is night or day, and whether data provided by a weather server connected to the evaluation center via the data network 11. In a further possible embodiment, the calculation unit 6 derives automatically control data depending on the data of the exploration map EM. This control data can control exploration machines 12, in particular exploration drilling rigs. Further, it is possible to control exploration sensors 13 at the investigated area. These exploration sensors can for instance comprise acoustic sensors deployed in the investigated area. Further, the control data can also be used to move the exploration sensors 13 within the target surface TS to a specific location depending on the data of the exploration map EM. The exploration sensors 13 can also comprise chemical sensors, for instance to locate seeping chemicals leaking from a deposit of the respective natural resource.

In a possible embodiment, the calculated exploration map EM is a two-dimensional map comprising coordinates of likely locations of natural resources beneath the target surface TS. In a further possible embodiment, the exploration map EM can also comprise three-dimensional data modelling the location of natural resources beneath the target surface TS of the investigated area. In a possible implementation, the exploration map EM can comprise several map layers for illustrating one or several layers beneath the target surface TS. In a possible embodiment of the detection system 1 according to the present invention, the detection system is also adapted to select different satellites 2-i from a predetermined group of available satellites depending on their capabilities and depending on the searched natural resource. Further, the satellites 2-i can be selected depending on their position relatively to the target surface TS. In a preferred implementation, those satellites 2-i are selected which are closest to the target surface TS of the investigated area. In a still further possible embodiment of the detection system 1 according to the present invention, additional images can be taken by other flying objects, in particular aircrafts flying over the target surface TS.

1. A method for detection of natural resources beneath a target surface of an area under investigation,
said method comprising the steps of:
remote sensing of electromagnetic radiation received from said target surface to provide satellite images of the investigated area;
processing the satellite images of the investigated area to generate analytical maps (AM) of said investigated area; and
calculating an exploration map of likely locations of natural resources beneath the target surface of said investigated area by superimposing generated analytical maps.

2. The method according to claim 1, wherein the exploration map of likely locations of natural resources beneath the target surface of the investigated area is calculated by superimposing at least two independently generated analytical maps.

3. The method according to claim 1, wherein satellite images of the investigated area are processed to generate an analytical structural trapping map of the investigated area indicating geological arc and/or ring structures beneath the target surface of the investigated area which indicate potential trapping mechanisms for trapping natural resources.

4. The method according to claim 1, wherein infrared satellite images of the investigated area are processed to generate an analytical thermal anomalies map of the investigated area indicating anomalies caused by natural resources beneath the target surface (TS) of the investigated area.

5. The method according to claim 1, wherein satellite images of the investigated area are processed to generate at least one analytical spectral brightness anomalies map of the investigated area indicating anomalies caused by natural resources beneath the target surface of the investigated area.

6. The method according claim 5, wherein the analytical thermal anomalies map and the at least one analytical spectral brightness anomalies map are superimposed to generate an analytical seepage map of the investigated area.

7. The method according to claim 6, wherein the generated analytical seepage map and the generated analytical structural trapping map are superimposed to calculate the exploration map of the investigated area.

8. The method according to claim 1, wherein geological data, lithological data and/or geophysical data of the investigated area are superimposed to said exploration map comprising coordinates of likely locations of natural resources beneath the target surface of the investigated area.

9. The method according to claim 1, wherein satellite images are provided by different satellites and transmitted to a base station connected to at least one calculation unit adapted to process the received satellite images to generate the independent analytical maps of the investigated area, wherein the received satellite images are selected and processed by the calculation unit depending on an exploration task indicating a type of the searched natural resources to be explored in the investigated area to generate independent analytical maps suited for the respective natural resource, wherein the geological, lithological, and geophysical data superimposed to said exploration map of the investigated area are selected and processed depending on the exploration task indicating the type of the searched natural resource to be explored in the investigated area.

10. The method according to claim 1, wherein the remote sensing of the electromagnetic radiation is performed by satellites which measure an electromagnetic radiation emitted by the target surface or reflected by the target surface to provide satellite images of the investigated area or wherein the remote sensing of electromagnetic radiation is performed by satellites which transmit electromagnetic signals to the target surface and measure an electromagnetic radiation reflected by the target surface in response to said electromagnetic signals to generate satellite images of the investigated area, wherein the satellite images are provided for electromagnetic radiation emitted or reflected by said target surface in different spectral ranges, wherein the spectral ranges of the satellite images are selected depending on the type of a natural resource indicated in the exploration task input by a user.

11. The method according to claim 1, wherein the calculated exploration map comprises statistical data indicating probabilities of the availability and/or distribution and/or motion of a natural resource at geographical coordinates beneath the target surface within the investigated area.

12. The method according to claim 1, wherein control data adapted to control exploration machines and/or to control exploration sensors at the investigated area are derived from the calculated exploration map.

13. A detection system for detection of natural resources beneath a target surface of an area under investigation comprising:
a calculation unit adapted to calculate an exploration map of likely locations of natural resources beneath the target surface of the investigated area by superimposing independent analytical maps of the investigated area generated by processing satellite images of the investigated area provided by satellites.

14. The detection system according to claim 13, wherein the calculation unit is adapted to calculate the exploration map (EM) of natural resources beneath the target surface of the investigated area by superimposing the independent analytical maps (AM) of the investigated area stored in a first database and geological data, lithological data and/or geophysical data of the investigated area stored in second databases connected to the calculation unit of the detection system.

15. The detection system according to claim 13, wherein the satellite images received from said satellites are stored in an image data memory of said detection system and processed by the calculation unit of the detection system to generate the independent analytical maps (AM) of the investigated area stored in the first database of said detection system, wherein the satellite images stored in the image data memory are selected and processed by said calculation unit of the detection system to generate the independent analytical maps depending on an exploration task indicating a type of the searched natural resource to be explored input by a user into a user interface of said detection system.

16. The detection system according to claim 15, wherein the superimposing of the generated analytical maps of the investigated area stored in the first database of the detection system and the geological data, lithological data and/or geophysical data of the investigated area stored in the second databases connected to said detection system is performed by said calculation unit depending on the exploration task (ET) input by the user into the user interface of the detection system, wherein the calculation unit is adapted to derive control data to control exploration machines and/or exploration sensors at the investigated area on the basis of the calculated exploration map and to output the exploration map to said user via an interface.
